(19) United States
(12) Patent Application Publication
(10) Pub. No.: US 2016/0134607 A1
(43) Pub. Date: May 12, 2016

(54) METHOD OF RSVP AUTHENTICATION WITH NON-DIRECTLY CONNECTED NEIGHBOR

(71) Applicant: Telefonaktiebolaget L M Ericsson (publ), Stockholm (SE)

(72) Inventor: Hua Autumn Liu, Mount Hamilton, CA (US)

(21) Appl. No.: 14/536,264

(22) Filed: Nov. 7, 2014

(51) Int. Cl. H04L 29/06

(52) U.S. Cl. CPC H04L 63/08

(57) ABSTRACT

A method is executed by a network device for authenticating resource reservation protocol (RSVP) messages between a sending node and a receiving node where the sending node and receiving node are directly or indirectly connected. The method authenticates RSVP messages using a security association between the sending node and the receiving node and an authentication key based on an address of the sending node and an address of the receiving node. The method includes generating an RSVP message to be sent to the receiving node, determining the security association for the sending node and receiving node pair, generating an integrity object for the RSVP message, determining an authentication key for the integrity object using the sending node address and the receiving node address, inserting the authentication key into the integrity object, and sending the RSVP message toward the receiving node.

### FIELD

Embodiments of the invention relate to the field of resource reservation protocol (RSVP) message authentication; and more specifically, to a method of managing security associations between a receiving node and sending node for RSVP messaging that enables authentication when the receiving node and sending node are indirectly connected.

### BACKGROUND

The Resource reSerVation Protocol RSVP is a protocol for setting up a label switched path (LSP) in routers and hosts, and in particular for reserving resources for providing differing qualities of service. RSVP allows particular users to obtain preferential access to network resources. This reservation of network resources is performed under the control of an admission control mechanism. Permission to make a reservation of network resources will depend both upon the availability of the requested network resources along the path of the data, and upon satisfaction of policy rules RFC 2747 provides a mechanism to protect RSVP message hop-by-hop. The method defined by RFC 2747 transmits an authentication digest of the RSVP message using an authentication key and a keyed-hash algorithm, therefore this method provides a protection against faked message or message modification. In addition, RFC 2747 introduces an integrity object to be added to each RSVP message. The integrity object includes a one-time-use sequence number. This number can be used by the receiver of the message to check if the message is played back so that replay can be prevented.

An RSVP message consists of a sequence of “objects,” which are type-length-value encoded fields having specific purposes. The information required for hop-by-hop integrity checking is carried in the integrity object. The integrity object includes the sequence number, which can be an unsigned 64-bit monotonically increasing unique sequence number. Sequence number values may be any monotonically increasing sequence that provides the integrity object of each RSVP message with a tag that is unique for the associated key's lifetime. The integrity object also includes a keyed message digest.

The sending and receiving nodes for RSVP messages maintain a security association for each authentication key that they share. This security association includes the following parameters, an authentication algorithm and algorithm mode being used, key used with the authentication algorithm, lifetime of the key, associated sending interface and other security association selection criteria, a source address of the sending system, the latest sending sequence number used with this key identifier, and a list of the last N sequence numbers received with this key identifier.

### SUMMARY

A method is executed by a network device for authenticating resource reservation protocol (RSVP) messages between a sending node and a receiving node where the sending node and receiving node are directly or indirectly connected. The method authenticates RSVP messages using a security association between the sending node and the receiving node and an authentication key based on an address of the sending node and an address of the receiving node. The method includes generating an RSVP message to be sent to the receiving node, determining the security association for the sending node and receiving node pair, generating an integrity object for the RSVP message, determining an authentication key for the integrity object using the sending node address and the receiving node address, inserting the authentication key into the integrity object, generating a sequence number for the message and sending the RSVP message toward the receiving node.

Another method is executed by a network device for authenticating resource reservation protocol (RSVP) messages between a sending node and a receiving node where the sending node and receiving node are directly or indirectly connected. The method authenticates RSVP messages using a security association between the sending node and the receiving node and an authentication key based on an address of the sending node and an address of the receiving node. The method includes receiving an RSVP message originating at the sending node, accessing an authentication key in an integrity object of the RSVP message, checking whether the authentication key and sequence number of the RSVP message match an authentication key for the security association of the sending node and receiving node pair, and authenticating the RSVP message where the authentication key of the RSVP message matches the authentication key of the security association.

A network device is configured or instructed to implement a method for authenticating resource reservation protocol (RSVP) messages between a sending node and a receiving node where the sending node and receiving node are directly or indirectly connected. The method authenticates RSVP messages using a security association between the sending node and the receiving node and an authentication key based on an address of the sending node and an address of the receiving node. The network device includes a non-transitory computer-readable medium having stored therein an RSVP module, and a network processor coupled to the non-transitory computer readable medium. The network processor is configured to execute the RSVP module. The RSVP module is configured to generate an RSVP message to be sent to the receiving node, determine the security association for the sending node and receiving node pair, generate an integrity object for the RSVP message, determine an authentication key for the integrity object using the sending node address and the receiving node address, insert the authentication key into the integrity object, generate a sequence number for the message and send the RSVP message toward the receiving node.

A network device configured to implement a method for authenticating resource reservation protocol (RSVP) messages between a sending node and a receiving node where the sending node and receiving node are directly or indirectly connected, the method to authenticate RSVP messages using a security association between the sending node and the receiving node and an authentication key based on an address of the sending node and an address of the receiving node. The network device includes a non-transitory computer-readable medium having stored therein an RSVP module, and a network processor coupled to the non-transitory computer readable medium. The network processor is configured to execute the RSVP module. The RSVP module is configured to receive an RSVP message originating at the sending node, access an authentication key in an integrity object of the RSVP message, check whether the authentication key and sequence number of the RSVP message match an authentication key for the security association of the sending node and receiving node pair, and authenticate the RSVP message where the authentication key of the RSVP message matches the authentication key of the security association.

A computing device implements a plurality of virtual machines for implementing network function virtualization (NFV). The virtual machine from the plurality of virtual machines is configured to execute a method for authenticating resource reservation protocol (RSVP) messages between a sending node and a receiving node. The sending node and receiving node are directly or indirectly connected. The method authenticates RSVP messages using a security association between the sending node and the receiving node and an authentication key based on an address of the sending node and an address of the receiving node. The computing device including a non-transitory computer-readable medium having stored therein an RSVP module and a processor coupled to the non-transitory computer readable medium. The processor is configured to execute the virtual machine. The virtual machine executes the RSVP module. The RSVP module is configured to generate an RSVP message to be sent to the receiving node, determine the security association for the sending node and receiving node pair, generate an integrity object for the RSVP message, determine an authentication key for the integrity object using the sending node address and the receiving node address, insert the authentication key into the integrity object, generate a sequence number for the message and send the RSVP message toward the receiving node.

A computing device implements a plurality of virtual machines for implementing network function virtualization (NFV). A virtual machine from the plurality of virtual machines is configured to execute a method for authenticating resource reservation protocol (RSVP) messages between a sending node and a receiving node. The sending node and receiving node are directly or indirectly connected. The method authenticates RSVP messages using a security association between the sending node and the receiving node and an authentication key based on an address of the sending node and an address of the receiving node. The computing device comprises a non-transitory computer-readable medium having stored therein an RSVP module, and a processor coupled to the non-transitory computer readable medium. The processor is configured to execute the virtual machine. The virtual machine is configured to execute the RSVP module. The RSVP module is configured to receive an RSVP message originating at the sending node, access an authentication key in an integrity object of the RSVP message, check whether the authentication key and sequence number of the RSVP message match an authentication key for the security association of the sending node and receiving node pair, and authenticate the RSVP message where the authentication key of the RSVP message matches the authentication key of the security association.

A control plane device implements at least one centralized control plane for a software defined network (SDN). The centralized control plane is configured to execute a method for authenticating resource reservation protocol (RSVP) messages between a sending node and a receiving node where the sending node and receiving node are directly or indirectly connected. The method authenticates RSVP messages using a security association between the sending node and the receiving node and an authentication key based on an address of the sending node and an address of the receiving node. The control plane device a non-transitory computer-readable medium having stored therein an RSVP module, and a processor coupled to the non-transitory computer readable medium. The processor is configured to execute the RSVP module. The RSVP module is configured to generate an RSVP message to be sent to the receiving node, determine the security association for the sending node and receiving node pair, generate an integrity object for the RSVP message, determine an authentication key for the integrity object using the sending node address and the receiving node address, insert the authentication key into the integrity object, generate a sequence number for the message and send the RSVP message toward the receiving node.

A control plane device implements at least one centralized control plane for a software defined network (SDN). The centralized control plane is configured to execute a method for authenticating resource reservation protocol (RSVP) messages between a sending node and a receiving node where the sending node and receiving node are directly or indirectly connected. The method authenticates RSVP messages using a security association between the sending node and the receiving node and an authentication key based on an address of the sending node and an address of the receiving node. The control plane device includes a non-transitory computer-readable medium having stored therein an RSVP module, and a processor coupled to the non-transitory computer readable medium. The processor is configured to execute the RSVP module. The RSVP module is configured to receive an RSVP message originating at the sending node, access an authentication key in an integrity object of the RSVP message, check whether the authentication key and sequence number of the RSVP message match an authentication key for the security association of the sending node and receiving node pair, and authenticate the RSVP message where the authentication key of the RSVP message matches the authentication key of the security association.

### BRIEF DESCRIPTION OF THE DRAWINGS

The invention may best be understood by referring to the following description and accompanying drawings that are used to illustrate embodiments of the invention. In the drawings:

FIG. 1 is a diagram of an example network topology including a sending node and a receiving node using RSVP.

FIG. 2 is a flowchart of one embodiment of a process for generating an RSVP message.

FIG. 3 is a flowchart of one embodiment of a process for authenticating an RSVP message.

FIG. 4 is a diagram of one embodiment of a network device (ND) implementing the RSVP authentication process.

FIG. 5A illustrates connectivity between network devices (NDs) within an exemplary network, as well as three exemplary implementations of the NDs, according to some embodiments of the invention.

FIG. 5B illustrates an exemplary way to implement the special-purpose network device 502 according to some embodiments of the invention.

FIG. 5C illustrates various exemplary ways in which virtual network elements (VNEs) may be coupled according to some embodiments of the invention.

FIG. 5D illustrates a network with a single network element (NE) on each of the NDs of FIG. 5A, and within this straight forward approach contrasts a traditional distributed approach (commonly used by traditional routers) with a centralized approach for maintaining reachability and forwarding information (also called network control), according to some embodiments of the invention.

FIG. 5E illustrates the simple case of where each of the NDs 500A-H implements a single NE 570A-H (see FIG. 5D), but the centralized control plane 576 has abstracted multiple of the NEs in different NDs (the NEs 570A-C and G-H) into (to represent) a single NE 570I in one of the virtual network(s) 592 of FIG. 5D, according to some embodiments of the invention.

FIG. 5F illustrates a case where multiple VNEs (VNE 570A.1 and VNE 570H.1) are implemented on different NDs (ND 500A and ND 500H) and are coupled to each other, and where the centralized control plane 576 has abstracted these multiple VNEs such that they appear as a single VNE 570T within one of the virtual networks 592 of FIG. 5D, according to some embodiments of the invention.

FIG. 6 illustrates a general purpose control plane device 604 including hardware 640 comprising a set of one or more processor(s) 642 (which are often Commercial off-the-shelf (COTS) processors) and network interface controller(s) 644 (NICs; also known as network interface cards) (which include physical NIs 646), as well as non-transitory machine readable storage media 648 having stored therein centralized control plane (CCP) software 650), according to some embodiments of the invention.

### DESCRIPTION OF EMBODIMENTS

The following description describes methods and apparatus for authenticating a resource reservation protocol (RSVP) message that supports indirect communication between the sending and receiving nodes. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Overview

As discussed above, the basic method for authenticating RSVP messages is defined by RFC 2747. The method define by RFC 2747 method works well with normal RSVP operation when the node sending the RSVP message is directly connected with the node receiving the RSVP message. However, when the sending node and the receiving node of the RSVP message are not directly connected, then the authentication method will fail to authenticate messages under main circumstances that can have deleterious effects on the services provided by the network. For example, failure to authenticate RSVP messages for a particular LSP can cause the LSP to go down and thereby causing traffic loss and service impact associated with that LSP. In one example, the authentication process defined in RFC 2747 will fail in networks implementing fast re-routing (FRR) between nodes.

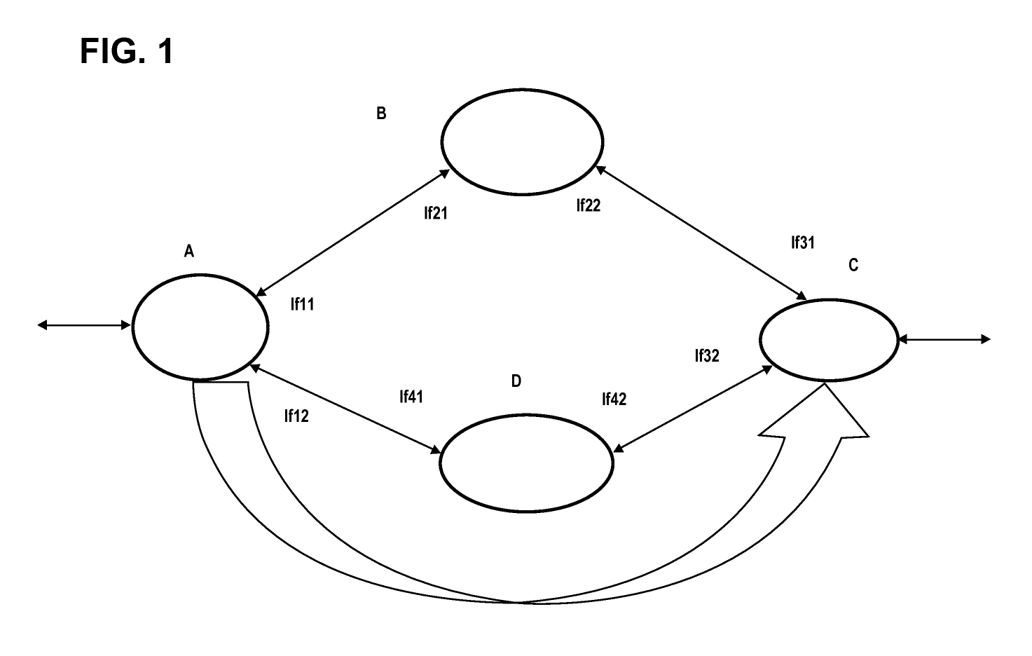

For example, the method of authentication defined in RFC 2747 fails in a network implementing multiprotocol label switching (MPLS) implementing FRR. An example of such a network is shown in FIG. 1. The example network of FIG. 1 is simplified by way of illustration to assist in understanding the embodiments. One skilled in the art would understand that the principles and methods described with relation with this example are applicable to any complexity of network topology or configuration. In the illustrated example a primary label switch path (LSP) has been established as A-B-C, a bypass LSP has been established as A-D-C to protect a failure on the link A-B or node failure at node B.

The RSVP authentication method of RFC 2747 works well for both LSPs before FRR is used. In this example, when the link A-B fails, the FRR is triggered, which automatically shifts the forwarding of data traffic including RSVP messages from the primary LSP to the bypass LSP. The RSVP Path message for the primary LSP is thus sent via the bypass LSP. The key and sequence number used in this RSVP Path message that would be forwarded now on interface A-D would not be recognized when the message reaches node C. Even if the same key were used on all nodes in the network, the sequence number generated by node A for interface A-B would be different from the sequence number generated by node D, leading the RSVP message with such an out of sequence number to be discarded and therefore the primary LSP would go down thereby making the FRR process unusable in connection with the authentication process of RFC 2747.

The embodiments of the invention overcome these limitations of the prior art by changing the management of the security association between the sending node and the receiving node. Specifically, the prior art security associations are maintained by only one of the sending node or the receiving node. In the embodiments of the invention, the security association is maintained by both of these peers (i.e. the sending node and the receiving node) and regardless of whether they are directly or indirectly connected. The key and sequence number are generated and verified between the peers. With the above example, after FRR, node A can send out the RSVP path message for the primary LSP with new keys and sequence number that receiving node C could understand and that would pass the verification process at the receiving node C so that the primary LSP can stay up when bypass LSP is used.

The authentication key can be configured or programmed by a key management protocol. If it is configured, then the key needs to be configured per pair of sending and receiving entities. If it is signaled, then the embodiments include processes to be implemented by the sending node and the receiving node. The sending node maintain the authentication key and the list of sequence numbers for a pair (i.e. a tuple) of a sending interface and a receiving node. When an RSVP message is sent from the sending interface toward the receiving node, the corresponding authentication key and sequence number are used.

At the receiving node, the authentication key and list of sequence numbers for a pair of a receiving interface and a sending node are also maintained. When an RSVP message is received on the receiving interface from the sending node, the corresponding key and sequence number is checked and verified. Thus, the method extends RSVP authentication to cover all cases particularly the FRR case and it is important that FRR is widely deployed and considered to be a key functionality of RSVP traffic engineering (TE).

The embodiments build on the functions of RSVP as described in RFC 2747 that utilize the admission control mechanisms of RSVP to protect against spoofing and similar replay attacks by using an authentication process. In other words, to ensure the integrity of the admission control mechanism, RSVP requires the ability to protect its messages against corruption and spoofing. The embodiments provided herein below define a basic mechanism to protect RSVP message integrity hop-by-hop. The embodiments, transmit an authenticating digest of the message, computed using a secret authentication key and a keyed-hash algorithm. The embodiments provide protection against forgery or message modification. The integrity object of each RSVP message is tagged with a one-time-use sequence number. This allows the message receiving node to identify playbacks (i.e., repeated messages) and thereby to thwart replay attacks.

The embodiments provide a method that does not afford confidentiality, since the RSVP messages stay in the clear; however, the mechanism is also exportable from most countries, which would be impossible were a privacy algorithm to be used. The terms sending node and receiving node are used here to refer to network devices that face each other across at least one RSVP hop, the “sending node” being the network device generating RSVP messages.

In one embodiment, the sending node generates RSVP message packets with monotonically increasing sequence numbers. In turn, the receiving node only accepts packets that have a larger sequence number than the previously received packet. To start this process, a receiving node handshakes with the sending node to get an initial sequence number. The embodiments provide a methods to relax the strictness of the in-order delivery of RSVP messages as well as techniques to generate monotonically increasing sequence numbers that are robust across sender failures and restarts.

The embodiments provide a method that is independent of a specific cryptographic algorithm. Thus, any cryptographic algorithm could be used such as a keyed-hashing for message authentication using HMAC-MD5. In other embodiments, other hashing algorithms can be utilized such as HMAC-SHA1, which provides a stronger hashing where warranted. Varying implementations are possible depending on the requisite characteristics of the network, such as whether greater security or speed are required. However, in the general case provided by way of example herein HMAC-MD5 is utilized and is suitable for most network as it has favorable performance characteristics.

The RSVP checksum can be disabled (i.e., set to zero) when the integrity object is included in an RSVP message, as the message digest is a much stronger integrity check. However in other embodiments, the RSVP checksum can continue to be utilized.

Returning to the example shown in FIG. 1, the example can be discussed in greater detail to contrast the operation in a scenario where message authentication is handled according to RFC 2747 and where the message authentication is handled according to an embodiment of the invention. In this example the network interfaces on node A are labeled if11, if12, the network interfaces on node B are labeled if21, if22, the network interfaces on node C are labeled if31, if32 and the network interfaces on node D are labeled if41, if42. An authentication key is configured/setup on each of the interface pairs. For if11 and if21 the key is abc; the authentication key configured/setup on if22 and if31 is xyz; the authentication key configured/setup on if12 and if41 is 123 and the authentication key configured/setup on if42 and if32 is 456.

As mentioned above, the network topology includes a primary LSP that originates at node A, traverses node B and reaches node C, its egress A bypass LSP going through nodes A, D, and C to protect the link between nodes A and B, i.e., link A-B. With the existing authentication method defined by RFC 2747, during normal operation the RSVP path and resv messages for the primary LSP and the bypass LSP would go through an authentication check at the receiving node C successfully with respective keys on each hop along the path being added, so that the primary LSP and bypass LSP would be remain up and functioning as long as these RSVP messages are authenticated at the receiving node C.

However, when a failure on link A-B occurs, the control message (i.e., the path message) for the primary LSP would be sent from the sending node A to the receiving node C via the bypass LSP. The outgoing interface on node A for the path message is if12 and the corresponding key 123 is encoded in the RSVMP message. When the message arrives on interface if32, the authentication check would be performed following the existing method of RFC 2747 and it would be fail because the key 123 does not match the expected key for the interface which is the key 456. The sequence number would also be incorrect or unknown to the receiving node C. As a result, the primary LSP would go down because its state would be aged out due to the failure to authenticate the incoming RSVP messages for that LSP causing them to be discarded and not processed properly by the receiving node C.

The method provided by the embodiments set forth herein would setup/configure and maintain the authentication key based on the sender (sending node A) address and receiving address (of receiving node C), unlike the existing method of RFC 2747, which is based on only the sending node address. For the above example, authentication key 123 is used for network interface pair (if12, if41), authentication key 456 is used for network authentication pair of network interfaces if42, if32, a new authentication key abc123 is used for the sending and receiving node pair (A, C) on node A and pair (C, A) on node C. When FRR is triggered, the RSVP path message for primary LSP will use abc123 because the message is sent from sending node A to receiving node C. On the receiving side the authentication check is performed against sending and receiving node pair (C, A) which matches. Accordingly, the RSVP messages are authenticated and not discarded at the receiving node C and in this scenario the primary LSP will stay up.

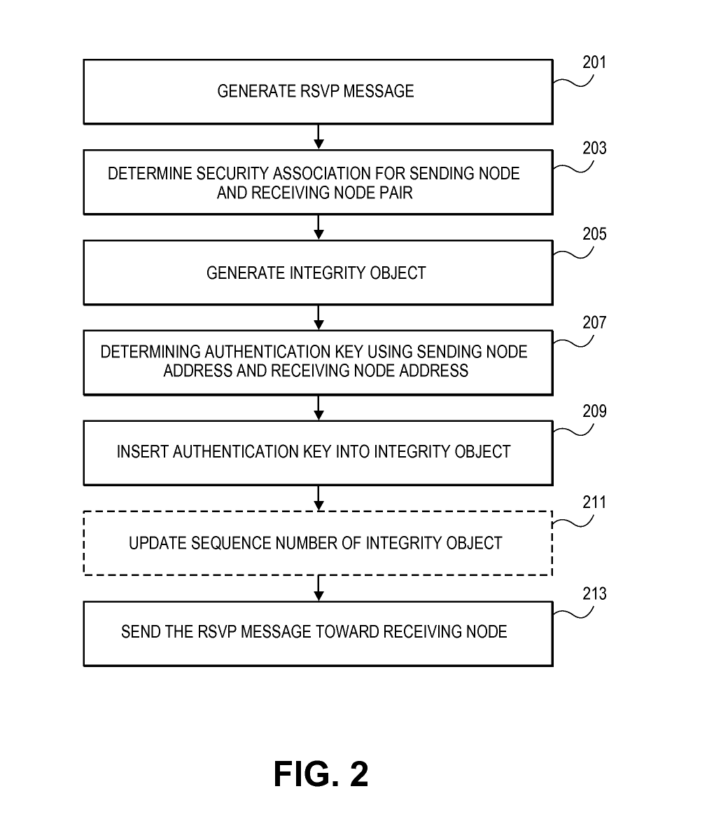

FIG. 2 is a flowchart of one embodiment of the process for RSVP message authentication at the sending node. The process is initiated whenever any of the RSVP messages (e.g., path or resv messages) need to be sent from the sending node to a receiving node and in particular in scenarios where the receiving node is not adjacent or directly connected to the sending node. The process generates the appropriate RSVP message to be sent to the receiving node over the corresponding network interface (Block 201). The scenarios assumes that a security association has already been established between the sending node and the receiving node with the security association stored in a key table and including both the sending node address and the receiving node address along with the associated authentication key to enable the authentication of messages between the sending and receiving nodes regardless of the route (e.g., LSP) over which the messages traversed the intermediate nodes of the network topology.

This security association is determined form the sending node and receiving node pair (Block 203). The security association can be determined by identifying the address of the sending node and the address of the receiving node, which can be provided as a parameter or similarly obtained. In other embodiments, the security association can be set up established through any protocol or procedure between the sending node and receiving node or through administrative mechanisms.

An integrity object can then be generated for the RSVP message (Block 205). The integrity object is utilized by the sending and receiving node to establish proper transmission of the RSVP message and receipt thereof at the receiving node. The integrity object also serve to avoid spoofing or replay attacks by use with a sequence key that prevents the same RSVP or a copy thereof from being processed multiple times.

The process can then determine the authentication key using a sending node and receiving node address (Block 207). The authentication key can be looked up in a key table if previously generated or can be generated using any cryptographic algorithm. The authentication key can then be inserted into the integrity object (Block 209). The sequence number for the integrity object can then be set to be the next sequence number for the security association as determined from the key table or derived therefrom (Block 211). Once the integrity object has been successfully updated with this information it can then be sent toward the receiving node using the outbound interface specified in the key table entry for the sending node and receiving node pair.

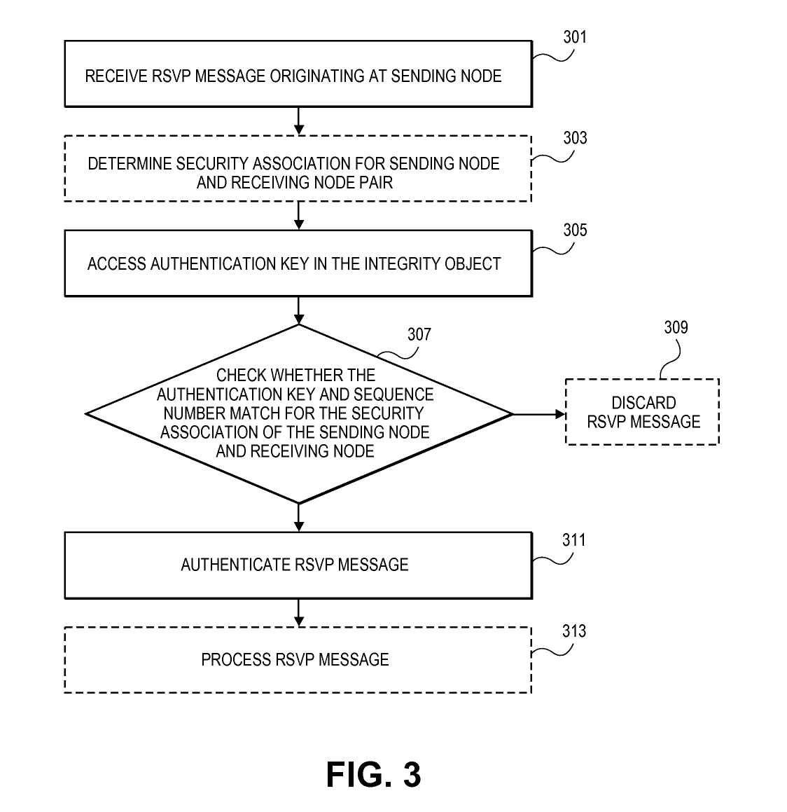

FIG. 3 is a flowchart of one embodiment of the process for RSVP message authentication at the receiving node. This process is carried out at the receiving node in response to receiving an RSVP message (Block 301). The receiving node maintains a key table with information mirroring that of the sending node with regard to the security association for the sending node and receiving node pair. Upon receiving the RSVP message the receiving node determines the security association of the incoming RSVP message using the sending node address and the receiving node address (Block 303).

The authentication key in the integrity object of the received RSVP node is then retrieved (Block 305). The sequence number can also be retrieved from the integrity object. The sequence number and authentication key can then be compared with the authentication key and sequence number expected for the security association for the sending node and receiving node pair to determine whether a match exists (Block 307). Where either the authentication key or the sequence number do not match, then the received RSVP message cannot be authenticated and is discarded (Block 309). However, if both do match, then the RSVP message is authenticated (Block 311) and the RSVP message can then be further processed according to its type (Block 313).

The operations in the flow diagrams are described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

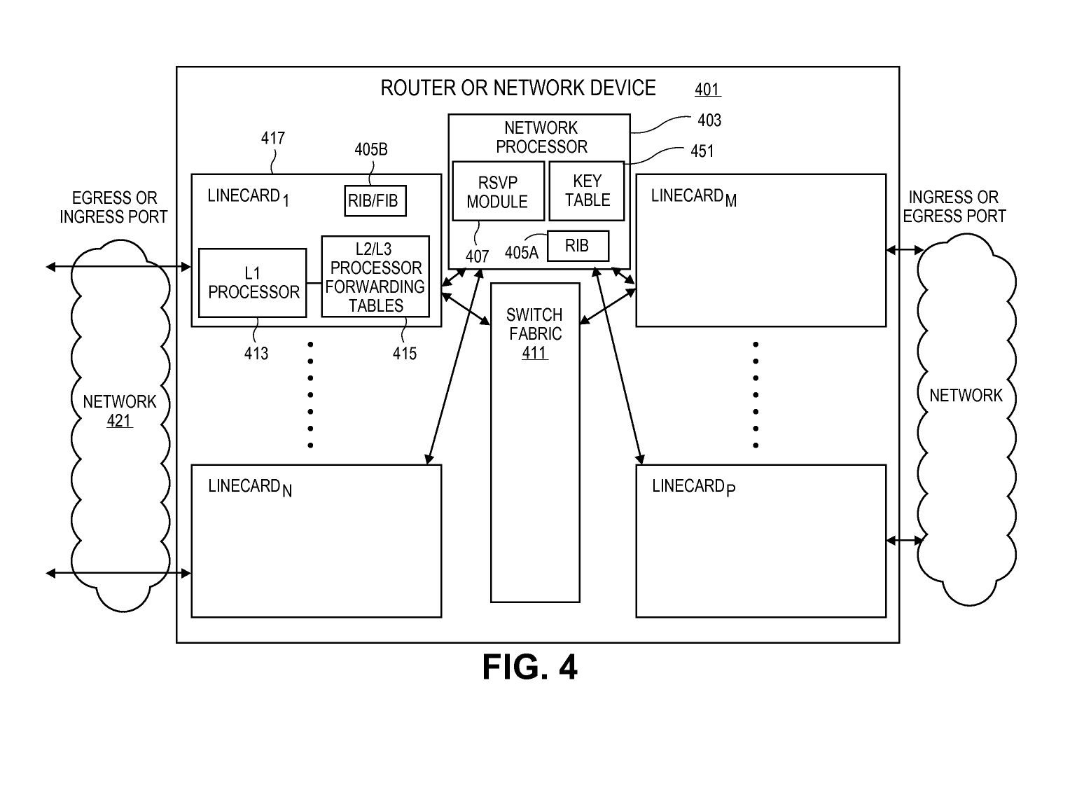

FIG. 4 is a diagram of one embodiment of a network device implementing RSVP message authentication that supports indirectly connected nodes.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

In one embodiment, the process is implemented by a network device 401 or similar computing device. The network device 401 can have any structure that enables it to receive data traffic and forward it toward its destination. The network device 401 can include a network processor 403 or set of network processors that execute the functions of the network device 401. A ‘set,’ as used herein, is any positive whole number of items including one item. The network device 401 can execute an RSVP module 407 to implement the functions of message authentication for indirectly connected sending and receiving nodes as described herein above via a network processor 403. The network processor 403 can also maintain a key table 408 that includes the security association information for sending node and receiving node pairs including authentication keys, sequence numbers, source node addresses, receiving node addresses and similar information.

The network processor 403 can implement the RSVP module 407 and/or the key table 408 as a discrete hardware, software module or any combination thereof. The network processor 403 can also service the routing information base 405A and similar functions related to data traffic forwarding and network topology maintenance. The routing information base 405A can be implemented as match action tables that are utilized for forwarding protocol data units PDUs (i.e. packets). The functions of the RSVP module 407 and key table 408 can be implemented as modules in any combination of software, including firmware, and hardware within the network device. The functions of the RSVP module 407 and key table 408 that are executed and implemented by the network device 401 include those described further herein above.

In one embodiment, the network device 401 can include a set of line cards 417 that process and forward the incoming data traffic toward the respective destination nodes by identifying the destination and forwarding the data traffic to the appropriate line card 417 having an egress port that leads to or toward the destination via a next hop. These line cards 417 can also implement the forwarding information base 405B, or a relevant subset thereof. The line cards 417 can also implement or facilitate the RSVP module 407 and key table 408 functions described herein above. The line cards 417 are in communication with one another via a switch fabric 411 and communicate with other nodes over attached networks 421 using Ethernet, fiber optic or similar communication links and media.

As described herein, operations performed by the network device 401 may refer to specific configurations of hardware such as application specific integrated circuits (ASICs) configured to perform certain operations or having a predetermined functionality, or software instructions stored in memory embodied in a non-transitory computer readable storage medium. Thus, the techniques shown in the figures can be implemented using code and data stored and executed on one or more electronic devices (e.g., an end station, a network element). Such electronic devices store and communicate (internally and/or with other electronic devices over a network) code and data using computer -readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals-such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. One or more parts of an embodiment of the invention may be implemented using different combinations of software, firmware, and/or hardware.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) to establish network connections (to transmit and/or receive code and/or data using propagating signals) with other electronic devices. One or more parts of an embodiment of the invention may be implemented using different combinations of software, firmware, and/or hardware

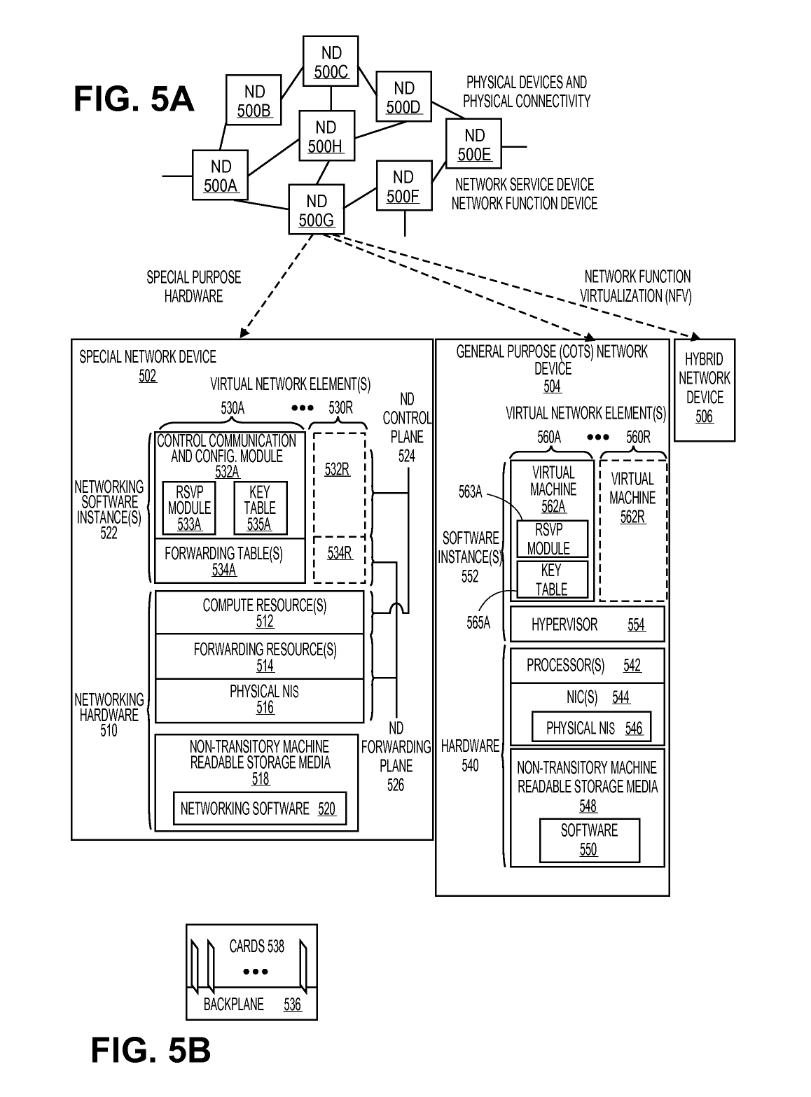

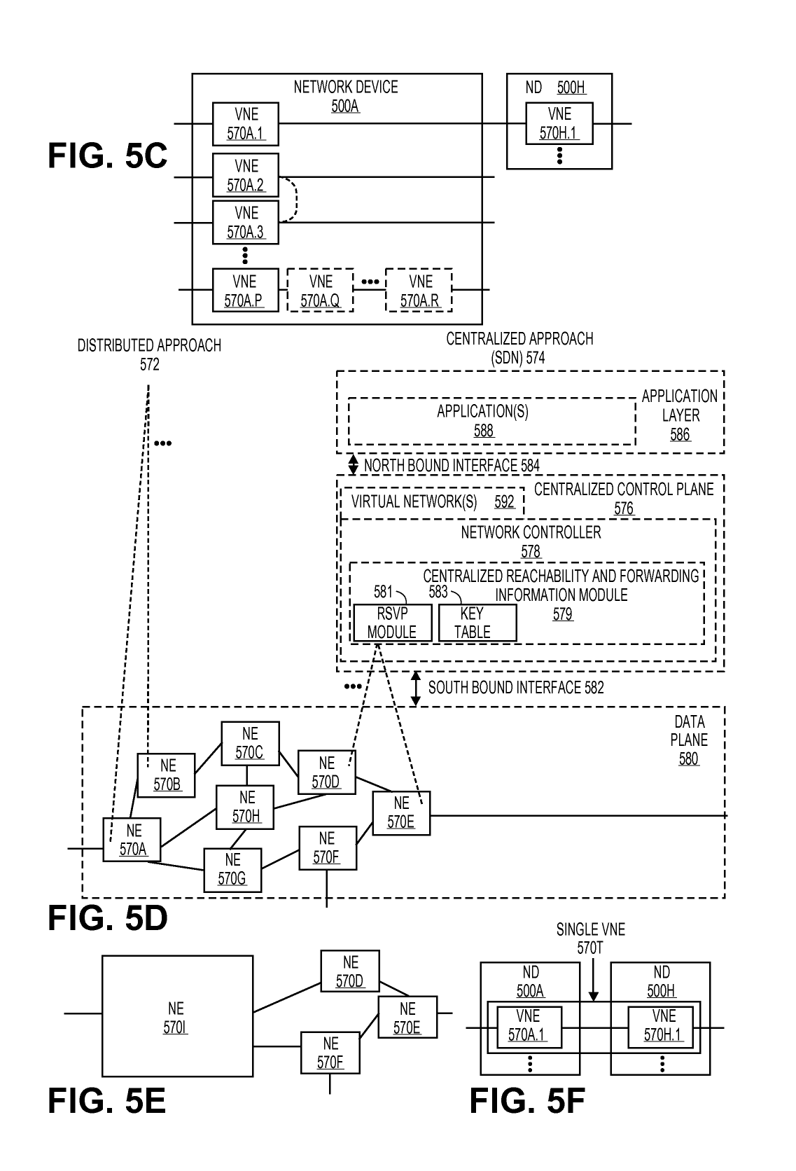

FIG. 5A illustrates connectivity between network devices (NDs) within an exemplary network, as well as three exemplary implementations of the NDs, according to some embodiments of the invention. FIG. 5A shows NDs 500A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 500A, E, and F illustrates that these NDs act as ingress and egress points for the network (and thus, these NDs are sometimes referred to as edge NDs; while the other NDs may be called core NDs).

Two of the exemplary ND implementations in FIG. 5A are: 1) a special-purpose network device 502 that uses custom application—specific integrated—circuits (ASICs) and a proprietary operating system (OS); and 2) a general purpose network device 504 that uses common off-the-shelf (COTS) processors and a standard OS.

The special-purpose network device 502 includes networking hardware 510 comprising compute resource(s) 512 (which typically include a set of one or more processors), forwarding resource(s) 514 (which typically include one or more ASICs and/or network processors), and physical network interfaces (NIs) 516 (sometimes called physical ports), as well as non-transitory machine readable storage media 518 having stored therein networking software 520. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 500A-H. During operation, the networking software 520 may be executed by the networking hardware 510 to instantiate a set of one or more networking software instance(s) 522. Each of the networking software instance(s) 522, and that part of the networking hardware 510 that executes that network software instance (be it hardware dedicated to that networking software instance and/or time slices of hardware temporally shared by that networking software instance with others of the networking software instance(s) 522), form a separate virtual network element 530A-R. Each of the virtual network element(s) (VNEs) 530A-R includes a control communication and configuration module 532A-R (sometimes referred to as a local control module or control communication module) and forwarding table(s) 534A-R, such that a given virtual network element (e.g., 530A) includes the control communication and configuration module (e.g., 532A), a set of one or more forwarding table(s) (e.g., 534A), and that portion of the networking hardware 510 that executes the virtual network element (e.g., 530A). The virtual network elements 530A can also execute an RSVP module 533A and/or maintain a key table 535A as described herein above.

The special-purpose network device 502 is often physically and/or logically considered to include: 1) a ND control plane 524 (sometimes referred to as a control plane) comprising the compute resource(s) 512 that execute the control communication and configuration module(s) 532A-R; and 2) a ND forwarding plane 526 (sometimes referred to as a forwarding plane, a data plane, or a media plane) comprising the forwarding resource(s) 514 that utilize the forwarding table(s) 534A-R and the physical NIs 516. By way of example, where the ND is a router (or is implementing routing functionality), the ND control plane 524 (the compute resource(s) 512 executing the control communication and configuration module(s) 532A-R) is typically responsible for participating in controlling how data (e.g., packets) is to be routed (e.g., the next hop for the data and the outgoing physical NI for that data) and storing that routing information in the forwarding table(s) 534A-R, and the ND forwarding plane 526 is responsible for receiving that data on the physical NIs 516 and forwarding that data out the appropriate ones of the physical NIs 516 based on the forwarding table(s) 534A-R.

FIG. 5B illustrates an exemplary way to implement the special-purpose network device 502 according to some embodiments of the invention. FIG. 5B shows a special-purpose network device including cards 538 (typically hot pluggable). While in some embodiments the cards 538 are of two types (one or more that operate as the ND forwarding plane 526 (sometimes called line cards), and one or more that operate to implement the ND control plane 524 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec) (RFC 4301 and 4309), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 536 (e.g., a first full mesh coupling the line cards and a second full mesh coupling all of the cards).

Returning to FIG. 5A, the general purpose network device 504 includes hardware 540 comprising a set of one or more processor(s) 542 (which are often COTS processors) and network interface controller(s) 544 (NICs; also known as network interface cards) (which include physical NIs 546), as well as non-transitory machine readable storage media 548 having stored therein software 550. During operation, the processor(s) 542 execute the software 550 to instantiate a hypervisor 554 (sometimes referred to as a virtual machine monitor (VMM)) and one or more virtual machines 562A-R that are run by the hypervisor 554, which are collectively referred to as software instance(s) 552. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes. Each of the virtual machines 562A-R, and that part of the hardware 540 that executes that virtual machine (be it hardware dedicated to that virtual machine and/or time slices of hardware temporally shared by that virtual machine with others of the virtual machine(s) 562A-R), forms a separate virtual network element(s) 560A-R. The virtual machines 562A-R can each implement an RSVP module 563A-R and/or key table 565A-R.

The virtual network element(s) 560A-R perform similar functionality to the virtual network element(s) 530A-R. For instance, the hypervisor 554 may present a virtual operating platform that appears like networking hardware 510 to virtual machine 562A, and the virtual machine 562A may be used to implement functionality similar to the control communication and configuration module(s) 532A and forwarding table(s) 534A (this virtualization of the hardware 540 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the virtual machine(s) 562A-R differently. For example, while embodiments of the invention are illustrated with each virtual machine 562A-R corresponding to one VNE 560A-R, alternative embodiments may implement this correspondence at a finer level granularity (e.g., line card virtual machines virtualize line cards, control card virtual machine virtualize control cards, etc.); it should be understood that the techniques described herein with reference to a correspondence of virtual machines to VNEs also apply to embodiments where such a finer level of granularity is used.

In certain embodiments, the hypervisor 554 includes a virtual switch that provides similar forwarding services as a physical Ethernet switch. Specifically, this virtual switch forwards traffic between virtual machines and the NIC(s) 544, as well as optionally between the virtual machines 562A-R; in addition, this virtual switch may enforce network isolation between the VNEs 560A-R that by policy are not permitted to communicate with each other (e.g., by honoring virtual local area networks (VLANs)).

The third exemplary ND implementation in FIG. 5A is a hybrid network device 506, which includes both custom ASICs/proprietary OS and COTS processors/standard OS in a single ND or a single card within an ND. In certain embodiments of such a hybrid network device, a platform VM (i.e., a VM that implements the functionality of the special-purpose network device 502) could provide for para-virtualization to the networking hardware present in the hybrid network device 506.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 530A-R, VNEs 560A-R, and those in the hybrid network device 506) receives data on the physical NIs (e.g., 516, 546) and forwards that data out the appropriate ones of the physical NIs (e.g., 516, 546). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP) (RFC 768, 2460, 2675, 4113, and 5405), Transmission Control Protocol (TCP) (RFC 793 and 1180), and differentiated services (DSCP) values (RFC 2474, 2475, 2597, 2983, 3086, 3140, 3246, 3247, 3260, 4594, 5865, 3289, 3290, and 3317).

FIG. 5C illustrates various exemplary ways in which VNEs may be coupled according to some embodiments of the invention. FIG. 5C shows VNEs 570A.1-570A.P (and optionally VNEs 570A.Q-570A.R) implemented in ND 500A and VNE 570H.1 in ND 500H. In FIG. 5C, VNEs 570A.1-P are separate from each other in the sense that they can receive packets from outside ND 500A and forward packets outside of ND 500A; VNE 570A.1 is coupled with VNE 570H.1, and thus they communicate packets between their respective NDs; VNE 570A.2-570A.3 may optionally forward packets between themselves without forwarding them outside of the ND 500A; and VNE 570A.P may optionally be the first in a chain of VNEs that includes VNE 570A.Q followed by VNE 570A.R (this is sometimes referred to as dynamic service chaining, where each of the VNEs in the series of VNEs provides a different service—e.g., one or more layer 4-7 network services). While FIG. 5C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 5A, for example, may form part of the Internet or a private network; and other electronic devices (not shown; such as end user devices including workstations, laptops, netbooks, tablets, palm tops, mobile phones, smartphones, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 5A may also host one or more such servers (e.g., in the case of the general purpose network device 504, one or more of the virtual machines 562A-R may operate as servers; the same would be true for the hybrid network device 506; in the case of the special-purpose network device 502, one or more such servers could also be run on a hypervisor executed by the compute resource(s) 512); in which case the servers are said to be co-located with the VNEs of that ND.

A virtual network is a logical abstraction of a physical network (such as that in FIG. 5A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN RFC 4364) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network-originated attacks, to avoid malformed route announcements), and management capabilities (e.g., full detection and processing).

FIG. 5D illustrates a network with a single network element on each of the NDs of FIG. 5A, and within this straight forward approach contrasts a traditional distributed approach (commonly used by traditional routers) with a centralized approach for maintaining reachability and forwarding information (also called network control), according to some embodiments of the invention. Specifically, FIG. 5D illustrates network elements (NEs) 570A-H with the same connectivity as the NDs 500A-H of FIG. 5A.

FIG. 5D illustrates that the distributed approach 572 distributes responsibility for generating the reachability and forwarding information across the NEs 570A-H; in other words, the process of neighbor discovery and topology discovery is distributed.

For example, where the special-purpose network device 502 is used, the control communication and configuration module(s) 532A-R of the ND control plane 524 typically include a reachability and forwarding information module to implement one or more routing protocols (e.g., an exterior gateway protocol such as Border Gateway Protocol (BGP) (RFC 4271), Interior Gateway Protocol(s) (IGP) (e.g., Open Shortest Path First (OSPF) (RFC 2328 and 5340), Intermediate System to Intermediate System (IS-IS) (RFC 1142), Routing Information Protocol (RIP) (version 1 RFC 1058, version 2 RFC 2453, and next generation RFC 2080)), Label Distribution Protocol (LDP) (RFC 5036), Resource Reservation Protocol (RSVP) (RFC 2205, 2210, 2211, 2212, as well as RSVP-Traffic Engineering (TE): Extensions to RSVP for LSP Tunnels RFC 3209, Generalized Multi-Protocol Label Switching (GMPLS) Signaling RSVP-TE RFC 3473, RFC 3936, 4495, and 4558)) that communicate with other NEs to exchange routes, and then selects those routes based on one or more routing metrics. Thus, the NEs 570A-H (e.g., the compute resource(s) 512 executing the control communication and configuration module(s) 532A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 524. The ND control plane 524 programs the ND forwarding plane 526 with information (e.g., adjacency and route information) based on the routing structure(s). For example, the ND control plane 524 programs the adjacency and route information into one or more forwarding table(s) 534A-R (e.g., Forwarding Information Base (FIB), Label Forwarding Information Base (LFIB), and one or more adjacency structures) on the ND forwarding plane 526. For layer 2 forwarding, the ND can store one or more bridging tables that are used to forward data based on the layer 2 information in that data. While the above example uses the special-purpose network device 502, the same distributed approach 572 can be implemented on the general purpose network device 504 and the hybrid network device 506.

FIG. 5D illustrates that a centralized approach 574 (also known as software defined networking (SDN)) that decouples the system that makes decisions about where traffic is sent from the underlying systems that forwards traffic to the selected destination. The illustrated centralized approach 574 has the responsibility for the generation of reachability and forwarding information in a centralized control plane 576 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 576 has a south bound interface 582 with a data plane 580 (sometime referred to the infrastructure layer, network forwarding plane, or forwarding plane (which should not be confused with a ND forwarding plane)) that includes the NEs 570A-H (sometimes referred to as switches, forwarding elements, data plane elements, or nodes). The centralized control plane 576 includes a network controller 578, which includes a centralized reachability and forwarding information module 579 that determines the reachability within the network and distributes the forwarding information to the NEs 570A-H of the data plane 580 over the south bound interface 582 (which may use the OpenFlow protocol). In some embodiments, the centralized reachability and forwarding information module 579 implements the RSVP module 581 and/or key table 583. This can include the sending functions and/or the receiving functions where the data plane nodes do not implement one of these functions. In other embodiments, the centralized implementation would not replicate these functions but rather configure the data plane nodes to have equivalent behavior. Thus, the network intelligence is centralized in the centralized control plane 576 executing on electronic devices that are typically separate from the NDs.

For example, where the special-purpose network device 502 is used in the data plane 580, each of the control communication and configuration module(s) 532A-R of the ND control plane 524 typically include a control agent that provides the VNE side of the south bound interface 582. In this case, the ND control plane 524 (the compute resource(s) 512 executing the control communication and configuration module(s) 532A-R) performs its responsibility for participating in controlling how data (e.g., packets) is to be routed (e.g., the next hop for the data and the outgoing physical NI for that data) through the control agent communicating with the centralized control plane 576 to receive the forwarding information (and in some cases, the reachability information) from the centralized reachability and forwarding information module 579 (it should be understood that in some embodiments of the invention, the control communication and configuration module(s) 532A-R, in addition to communicating with the centralized control plane 576, may also play some role in determining reachability and/or calculating forwarding information—albeit less so than in the case of a distributed approach; such embodiments are generally considered to fall under the centralized approach 574, but may also be considered a hybrid approach).

While the above example uses the special-purpose network device 502, the same centralized approach 574 can be implemented with the general purpose network device 504 (e.g., each of the VNE 560A-R performs its responsibility for controlling how data (e.g., packets) is to be routed (e.g., the next hop for the data and the outgoing physical NI for that data) by communicating with the centralized control plane 576 to receive the forwarding information (and in some cases, the reachability information) from the centralized reachability and forwarding information module 579; it should be understood that in some embodiments of the invention, the VNEs 560A-R, in addition to communicating with the centralized control plane 576, may also play some role in determining reachability and/or calculating forwarding information—albeit less so than in the case of a distributed approach) and the hybrid network device 506. In fact, the use of SDN techniques can enhance the NFV techniques typically used in the general purpose network device 504 or hybrid network device 506 implementations as NFV is able to support SDN by providing an infrastructure upon which the SDN software can be run, and NFV and SDN both aim to make use of commodity server hardware and physical switches.

FIG. 5D also shows that the centralized control plane 576 has a north bound interface 584 to an application layer 586, in which resides application(s) 588. The centralized control plane 576 has the ability to form virtual networks 592 (sometimes referred to as a logical forwarding plane, network services, or overlay networks (with the NEs 570A-H of the data plane 580 being the underlay network)) for the application(s) 588. Thus, the centralized control plane 576 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 5D shows the distributed approach 572 separate from the centralized approach 574, the effort of network control may be distributed differently or the two combined in certain embodiments of the invention. For example: 1) embodiments may generally use the centralized approach (SDN) 574, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 574, but may also be considered a hybrid approach.

While FIG. 5D illustrates the simple case where each of the NDs 500A-H implements a single NE 570A-H, it should be understood that the network control approaches described with reference to FIG. 5D also work for networks where one or more of the NDs 500A-H implement multiple VNEs (e.g., VNEs 530A-R, VNEs 560A-R, those in the hybrid network device 506). Alternatively or in addition, the network controller 578 may also emulate the implementation of multiple VNEs in a single ND. Specifically, instead of (or in addition to) implementing multiple VNEs in a single ND, the network controller 578 may present the implementation of a VNE/NE in a single ND as multiple VNEs in the virtual networks 592 (all in the same one of the virtual network(s) 592, each in different ones of the virtual network(s) 592, or some combination). For example, the network controller 578 may cause an ND to implement a single VNE (a NE) in the underlay network, and then logically divide up the resources of that NE within the centralized control plane 576 to present different VNEs in the virtual network(s) 592 (where these different VNEs in the overlay networks are sharing the resources of the single VNE/NE implementation on the ND in the underlay network).

On the other hand, FIGS. 5E and 5F respectively illustrate exemplary abstractions of NEs and VNEs that the network controller 578 may present as part of different ones of the virtual networks 592. FIG. 5E illustrates the simple case of where each of the NDs 500A-H implements a single NE 570A-H (see FIG. 5D), but the centralized control plane 576 has abstracted multiple of the NEs in different NDs (the NEs 570A-C and G-H) into (to represent) a single NE 570I in one of the virtual network(s) 592 of FIG. 5D, according to some embodiments of the invention. FIG. 5E shows that in this virtual network, the NE 570I is coupled to NE 570D and 570F, which are both still coupled to NE 570E.

FIG. 5F illustrates a case where multiple VNEs (VNE 570A.1 and VNE 570H.1) are implemented on different NDs (ND 500A and ND 500H) and are coupled to each other, and where the centralized control plane 576 has abstracted these multiple VNEs such that they appear as a single VNE 570T within one of the virtual networks 592 of FIG. 5D, according to some embodiments of the invention. Thus, the abstraction of a NE or VNE can span multiple NDs.

While some embodiments of the invention implement the centralized control plane 576 as a single entity (e.g., a single instance of software running on a single electronic device), alternative embodiments may spread the functionality across multiple entities for redundancy and/or scalability purposes (e.g., multiple instances of software running on different electronic devices).

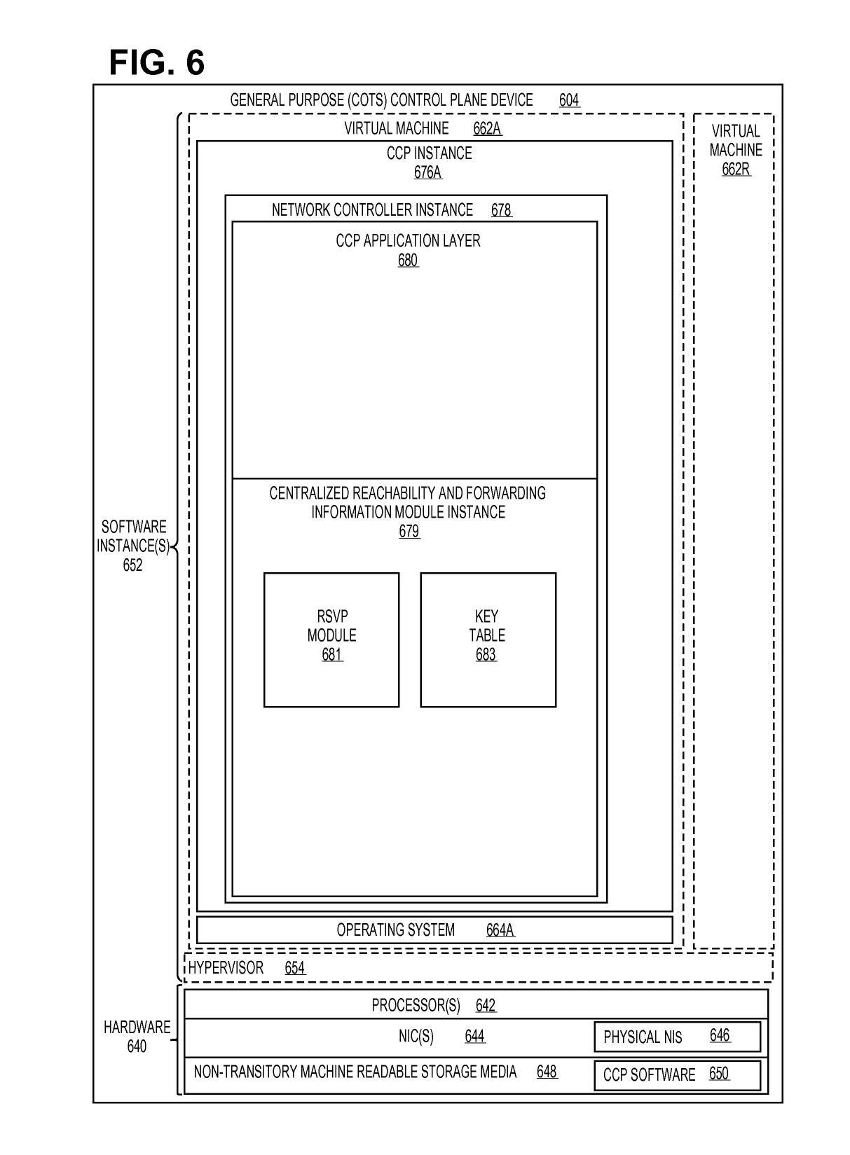

Similar to the network device implementations, the electronic device(s) running the centralized control plane 576, and thus the network controller 578 including the centralized reachability and forwarding information module 579, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 6 illustrates, a general purpose control plane device 604 including hardware 640 comprising a set of one or more processor(s) 642 (which are often COTS processors) and network interface controller(s) 644 (NICs; also known as network interface cards) (which include physical NIs 646), as well as non-transitory machine readable storage media 648 having stored therein centralized control plane (CCP) software 650.

In embodiments that use compute virtualization, the processor(s) 642 typically execute software to instantiate a hypervisor 654 (sometimes referred to as a virtual machine monitor (VMM)) and one or more virtual machines 662A-R that are run by the hypervisor 654; which are collectively referred to as software instance(s) 652. A virtual machine is a software implementation of a physical machine that runs programs as if they were executing on a physical, non-virtualized machine; and applications generally are not aware they are running on a virtual machine as opposed to running on a “bare metal” host electronic device, though some systems provide para-virtualization which allows an operating system or application to be aware of the presence of virtualization for optimization purposes. Again, in embodiments where compute virtualization is used, during operation an instance of the CCP software 650 (illustrated as CCP instance 676A) on top of an operating system 664A are typically executed within the virtual machine 662A. In embodiments where compute virtualization is not used, the CCP instance 676A on top of operating system 664A is executed on the “bare metal” general purpose control plane device 604.

The operating system 664A provides basic processing, input/output (I/O), and networking capabilities. In some embodiments, the CCP instance 676A includes a network controller instance 678. The network controller instance 678 includes a centralized reachability and forwarding information module instance 679 (which is a middleware layer providing the context of the network controller 578 to the operating system 664A and communicating with the various NEs), and an CCP application layer 680 (sometimes referred to as an application layer) over the middleware layer (providing the intelligence required for various network operations such as protocols, network situational awareness, and user-interfaces). In some embodiments, centralized reachability and forwarding information module instance can implement the RSVP module 681 and/or the key table 683. This can include the sending functions and/or the receiving functions where the data plane nodes do not implement one of these functions. In other embodiments, the centralized implementation would not replicate these functions but rather configure the data plane nodes to have equivalent behavior. At a more abstract level, this CCP application layer 680 within the centralized control plane 576 works with virtual network view(s) (logical view(s) of the network) and the middleware layer provides the conversion from the virtual networks to the physical view.

The centralized control plane 576 transmits relevant messages to the data plane 580 based on CCP application layer 680 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 580 may receive different messages, and thus different forwarding information. The data plane 580 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 580, the packet (or a subset of the packet header and content) is typically forwarded to the centralized control plane 576. The centralized control plane 576 will then program forwarding table entries into the data plane 580 to accommodate packets belonging to the flow of the unknown packet. Once a specific forwarding table entry has been programmed into the data plane 580 by the centralized control plane 576, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method executed by a network device for authenticating resource reservation protocol (RSVP) messages between a sending node and a receiving node where the sending node and receiving node are directly or indirectly connected, the method to authenticate RSVP messages using a security association between the sending node and the receiving node and an authentication key based on an address of the sending node and an address of the receiving node, the method comprising the steps of:
generating an RSVP message to be sent to the receiving node;
determining the security association for the sending node and receiving node pair;
generating an integrity object for the RSVP message;
determining an authentication key for the integrity object using the sending node address and the receiving node address;
inserting the authentication key into the integrity object; and
sending the RSVP message toward the receiving node.

2. The method of claim 1, further comprising the step of:
updating a sequence number for the integrity object.

3. The method of claim 1, wherein the RSVP message is any one of a path message or a reservation message.

4. A method executed by a network device for authenticating resource reservation protocol (RSVP) messages between a sending node and a receiving node where the sending node and receiving node are directly or indirectly connected, the method to authenticate RSVP messages using a security association between the sending node and the receiving node and an authentication key based on an address of the sending node and an address of the receiving node, the method comprising the steps of:
receiving an RSVP message originating at the sending node;
accessing an authentication key in an integrity object of the RSVP message;
checking whether the authentication key and sequence number of the RSVP message match an authentication key for the security association of the sending node and receiving node pair; and
authenticating the RSVP message where the authentication key of the RSVP message matches the authentication key of the security association.

5. The method of claim 4, further comprising:
determining the security association for the sending node and receiving node pair.

6. The method of claim 4, further comprising:
discarding the RSVP message where the authentication key of the RSVP message does not match the authentication key of the security association.

7. A network device configured to implement a method for authenticating resource reservation protocol (RSVP) messages between a sending node and a receiving node where the sending node and receiving node are directly or indirectly connected, the method to authenticate RSVP messages using a security association between the sending node and the receiving node and an authentication key based on an address of the sending node and an address of the receiving node, the network device comprising:
a non-transitory computer-readable medium having stored therein an RSVP module; and
a network processor coupled to the non-transitory computer readable medium, the network processor configured to execute the RSVP module, the RSVP module configured to generate an RSVP message to be sent to the receiving node, determine the security association for the sending node and receiving node pair, generate an integrity object for the RSVP message, determine an authentication key for the integrity object using the sending node address and the receiving node address, insert the authentication key into the integrity object, and send the RSVP message toward the receiving node.

8. The network device of claim 7, wherein the RSVP module is further configured to update a sequence number for the integrity object.

9. The network device of claim 7, wherein the RSVP message is any one of a path message or a reservation message.

10. A network device configured to implement a method for authenticating resource reservation protocol (RSVP) messages between a sending node and a receiving node where the sending node and receiving node are directly or indirectly connected, the method to authenticate RSVP messages using a security association between the sending node and the receiving node and an authentication key based on an address of the sending node and an address of the receiving node, the network device comprising:
a non-transitory computer-readable medium having stored therein an RSVP module; and
a network processor coupled to the non-transitory computer readable medium, the network processor configured to execute the RSVP module, the RSVP module configured to receive an RSVP message originating at the sending node, access an authentication key in an integrity object of the RSVP message, check whether the authentication key and sequence number of the RSVP message match an authentication key for the security association of the sending node and receiving node pair, and authenticate the RSVP message where the authentication key of the RSVP message matches the authentication key of the security association.

11. The network device of claim 10, wherein the RSVP module is further configured to determine the security association for the sending node and receiving node pair.

12. The network device of claim 10, wherein the RSVP module is further configured to discard the RSVP message where the authentication key of the RSVP message does not match the authentication key of the security association.

13. A computing device implementing a plurality of virtual machines for implementing network function virtualization (NFV), wherein a virtual machine from the plurality of virtual machines is configured to execute a method for authenticating resource reservation protocol (RSVP) messages between a sending node and a receiving node where the sending node and receiving node are directly or indirectly connected, the method to authenticate RSVP messages using a security association between the sending node and the receiving node and an authentication key based on an address of the sending node and an address of the receiving node, the computing device comprising:
a non-transitory computer-readable medium having stored therein an RSVP module; and
a processor coupled to the non-transitory computer readable medium, the processor configured to execute the virtual machine, the virtual machine to execute the RSVP module, the RSVP module configured to generate an RSVP message to be sent to the receiving node, determine the security association for the sending node and receiving node pair, generate an integrity object for the RSVP message, determine an authentication key for the integrity object using the sending node address and the receiving node address, insert the authentication key into the integrity object, and send the RSVP message toward the receiving node.

14. The computing device of claim 13, wherein the RSVP module is further configured to update a sequence number for the integrity object.

15. The computing device of claim 13, wherein the RSVP message is any one of a path message or a reservation message.

16. A computing device implementing a plurality of virtual machines for implementing network function virtualization (NFV), wherein a virtual machine from the plurality of virtual machines is configured to execute a method for authenticating resource reservation protocol (RSVP) messages between a sending node and a receiving node where the sending node and receiving node are directly or indirectly connected, the method to authenticate RSVP messages using a security association between the sending node and the receiving node and an authentication key based on an address of the sending node and an address of the receiving node, the computing device comprising:
a non-transitory computer-readable medium having stored therein an RSVP module; and
a processor coupled to the non-transitory computer readable medium, the processor configured to execute the virtual machine, the virtual machine configured to execute the RSVP module, the RSVP module configured to receive an RSVP message originating at the sending node, access an authentication key in an integrity object of the RSVP message, check whether the authentication key and sequence number of the RSVP message match an authentication key for the security association of the sending node and receiving node pair, and authenticate the RSVP message where the authentication key of the RSVP message matches the authentication key of the security association.

17. The computing device of claim 16, wherein the RSVP module is further configured to determine the security association for the sending node and receiving node pair.

18. The computing device of claim 16, wherein the RSVP module is further configured to discard the RSVP message where the authentication key of the RSVP message does not match the authentication key of the security association.

19. A control plane device to implement at least one centralized control plane for a software defined network (SDN), the centralized control plane configured to execute a method for authenticating resource reservation protocol (RSVP) messages between a sending node and a receiving node where the sending node and receiving node are directly or indirectly connected, the method to authenticate RSVP messages using a security association between the sending node and the receiving node and an authentication key based on an address of the sending node and an address of the receiving node, the control plane device comprising:
a non-transitory computer-readable medium having stored therein an RSVP module; and
a processor coupled to the non-transitory computer readable medium, the processor configured to execute the RSVP module, the RSVP module configured to generate an RSVP message to be sent to the receiving node, determine the security association for the sending node and receiving node pair, generate an integrity object for the RSVP message, determine an authentication key for the integrity object using the sending node address and the receiving node address, insert the authentication key into the integrity object, and send the RSVP message toward the receiving node.

20. The control plane device of claim 19, wherein the RSVP module is further configured to update a sequence number for the integrity object.

21. The control plane device of claim 19, wherein the RSVP message is any one of a path message or a reservation message.

22. A control plane device to implement at least one centralized control plane for a software defined network (SDN), the centralized control plane configured to execute a method for authenticating resource reservation protocol (RSVP) messages between a sending node and a receiving node where the sending node and receiving node are directly or indirectly connected, the method to authenticate RSVP messages using a security association between the sending node and the receiving node and an authentication key based on an address of the sending node and an address of the receiving node, the control plane device comprising:
a non-transitory computer-readable medium having stored therein an RSVP module; and
a processor coupled to the non-transitory computer readable medium, the processor configured to execute the RSVP module, the RSVP module configured to receive an RSVP message originating at the sending node, access an authentication key in an integrity object of the RSVP message, check whether the authentication key and sequence number of the RSVP message match an authentication key for the security association of the sending node and receiving node pair, and authenticate the RSVP message where the authentication key of the RSVP message matches the authentication key of the security association.

23. The control plane device of claim 22, wherein the RSVP module is further configured to determine the security association for the sending node and receiving node pair.

24. The control plane device of claim 22, wherein the RSVP module is further configured to discard the RSVP message where the authentication key of the RSVP message does not match the authentication key of the security association.
